(19) United States
(12) Patent Application Publication
(10) Pub. No.: US 2014/0249255 A1
(43) Pub. Date: Sep. 4, 2014

(54) FLAME RETARDANT RESIN COMPOSITION AND MOLDED PRODUCT

(71) Applicants: Tadakatsu Harada, Kanagawa (JP); Yasuyuki Matsushita, Aichi (JP); Kazuhiko Fukushima, Aichi (JP); Dan Aoki, Aichi (JP)

(72) Inventors: Tadakatsu Harada, Kanagawa (JP); Yasuyuki Matsushita, Aichi (JP); Kazuhiko Fukushima, Aichi (JP); Dan Aoki, Aichi (JP)

(73) Assignee: Ricoh Company, Ltd., Tokyo (JP)

(21) Appl. No.: 14/192,013

(22) Filed: Feb. 27, 2014

(30) Foreign Application Priority Data
Mar. 4, 2013 (JP) 2013-042155

(51) Int. Cl. C08L 69/00; C08L 9/06; C08L 67/04

(52) U.S. Cl. CPC C08L 69/00; C08L 67/04; C08L 9/06
USPC 524/73

(57) ABSTRACT

A flame retardant resin composition, containing a thermoplastic resin and a flame retardant, wherein the flame retardant contains a nitrogen-containing structure-introduced phosphorylated lignin derivative, wherein the nitrogen-containing structure-introduced phosphorylated lignin derivative is produced by introducing a nitrogen-containing structure into a lignin derivative and adding a phosphoric acid to the lignin derivative, or by adding a phosphoric acid to a lignin derivative and introducing a nitrogen-containing structure into the lignin derivative, or by introducing a nitrogen-containing structure into and adding a phosphoric acid to a lignin derivative simultaneously, and wherein the lignin derivative is obtained by subjecting a naturally occurring lignin to a treatment for allowing the naturally occurring lignin to be decomposed into small molecules or to be water-soluble.

### BACKGROUND OF THE INVENTION

1. Field of the Invention

The present invention relates to a flame retardant resin composition and a molded product that have excellent flame retardancy and are suitably usable in components for image output equipment such as copying machines and printers and electric/electronic equipment such as home electric appliances.

2. Description of the Related Art

A number of resin components are utilized, for example, for image output equipment such as copying machines and printers, electric/electronic equipment such as home electric appliances and interior components in automobiles. For these resin components, resin materials are required to have flame retardancy for the purpose of preventing fire spreading.

In particular, copying machines have in their interior a fixing unit that becomes an elevated temperature state, and resin materials are also used at portions around the fixing unit. Further, copying machines are provided with a unit for the generation of a high voltage such as a charging unit and a power supply unit such as a 100-V alternating current power supply unit. These units have a maximum power consumption of several hundreds of watts to 500 watts and are constituted by units utilizing a power system of 100 V and 15 A.

Such copying machines, mainly multifunction peripherals typified by multifunction printers, are stationary electric/electronic equipment, and, in international standards regarding flame retardancy of resin materials (IEC60950) that are one of safety standards for product equipment, ignition sources or portions in danger of ignition are required to be covered by an enclosure component having a flame retardancy level of “5V” as specified in UL94 standards (Underwriters Laboratories Inc., standard). The testing method for “5V” in UL94 standards is defined as “A combustion test by a 500-W testing flame” in international standards IEC60695-11-20 (ASTM D 5048).

For components for the construction of a copying machine body, interior components within the enclosure in addition to components for the enclosure are required to meet “V-2” or higher level in UL94 standards. The testing method for the “V-2” or higher level in UL94 standards is defined as “A 20-mm vertical combustion test” in international standards IEC60695-11-10, method B (ASTM D 3801).

Flame retardants that can be added to the resin material are divided into several types, and those commonly used are bromine flame retardants, phosphorus flame retardants, nitrogen compound flame retardants, silicone flame retardants, and inorganic flame retardants.

Flame retarding mechanisms of these flame retardants are already known in several documents, and three flame retarding mechanisms that are adopted particularly frequently will be described here.

The first flame retarding mechanism is one using halogen compounds typified by bromine flame retardants. For example, the halogen compounds are allowed to act as a negative catalyst in an oxidation reaction on a combustion flame to lower a combustion speed.

The second flame retarding mechanism is one using phosphorus flame retardants or silicone flame retardants. Bleeding of silicone flame retardants on the surface of the resin during combustion or a dehydration reaction of phosphorus flame retardants within the resin results in the production of carbide (char) on the surface of the resin to form a heat insulating film that stops combustion.

The third flame retarding mechanism is one using inorganic flame retardants such as magnesium hydroxide or aluminum hydroxide. The combustion is stopped, for example, by cooling the whole resin through the utilization of an endothermic reaction that takes place upon the decomposition of these compounds by the combustion of the resin, or an evaporative latent heat possessed by the produced water.

On the other hand, conventional resin materials are made of plastic materials using petroleum as a starting material. In recent years, however, attention has been drawn to biomass-derived resins using, for example, plants as a starting material. The biomass resource means that organisms such as plants or animals are used as a resource. Examples of the biomass resources include woods, corns, fats and oils from soybeans or animals, and raw refuses. The biomass-derived resins are produced using these biomass resources as starting materials. Biodegradable resins are also generally known. Biodegradation refers to a function of being degraded by, for example, microorganisms under certain environments in terms of temperature and humidity.

Some biodegradable resins are resins that are not the biomass-derived resins but petroleum-derived resins and have a biodegradation activity.

The biomass-derived resins include poly lactic acid (PLA) produced by chemical polymerization using, as a monomer, lactic acid produced by fermenting saccharides such as potatoes, sugar canes, and corns; esterified starches composed mainly of starch; microorganism-producing resins (PHA; poly hydroxy alkanoate) that are polyesters produced in microorganism bodies; and PTT (poly trimethylene terephthalate) produced by a fermentation method using, as starting materials, 1,3-propanediol and petroleum-derived terephthalic acid.

At the present time, petroleum-derived starting materials are used. However, studies are advanced aiming at the transfer of resins produced using petroleum-derived starting materials adopted at the present time to the biomass-derived resins in the future. For example, succinic acid that is one of main starting materials for PBS (poly butylene succinate) is produced using a plant-derived starting material. Among such biomass-derived resins, products produced by applying poly lactic acid that has a high melting point of around 180° C., possesses excellent moldability, and can be stably supplied to the market are becoming realized.

The poly lactic acid, however, has a low glass transition point of 56° C. and, for this reason, has a low thermal deformation temperature of around 55° C., indicating that the poly lactic acid has low heat resistance. In addition, since the poly lactic acid is a crystalline resin, the impact resistance is also low and is 1 kJ/m² to 2 kJ/m² in terms of Izod impact strength, making it difficult to adopt the poly lactic acid in durable members such as electric/electronic equipment products.

In order to overcome the above drawbacks, an attempt has been made to improve physical properties, for example, by adopting a polymer alloy of the biomass-derived resin with a polycarbonate resin that is a petroleum resin. According to this technique, however, the content of the petroleum resin is high and the content of the biomass-derived resin is around 50%, and, consequently, the effect of reducing the amount of fossils used and reducing the amount of carbon dioxide emissions for environmental load reduction purposes such as global warming countermeasure is disadvantageously reduced by half.

For example, Japanese Patent Application Laid-Open (JP-A) No. 2005-23260 proposes an electric/electronic component produced by molding a resin composition containing 1 part by mass to 350 parts by mass, based on 100 parts by mass of a plant-derived resin, of a naturally occurring organic filler, the plant-derived resin being a poly lactic acid resin, the naturally occurring organic filler being at least one filler selected from paper powder and wood powder, 50% by mass or more of the paper powder being accounted for by a used paper powder. The claimed advantage of this proposal is to improve the mechanical strength of the resin by the addition of naturally occurring organic fillers such as paper powder to poly lactic acid. For flame retardancy purposes, however, 23 parts by mass to 29 parts by mass, based on 100 parts by mass of the poly lactic acid, of fossil-derived flame retardants such as phosphorus flame retardants should be added. Even when the resin material is changed to biomass materials as a base for environment load reduction purposes, the use of the large amount of fossil-derived flame retardants spoils the effect attained by the use of the biomass materials.

JP-A No. 2005-162872 proposes a resin composition containing at least one biodegradable organic polymeric compound, a flame retardant additive containing a phosphorus-containing compound, and at least one hydrolysis inhibitor that inhibits the hydrolysis of the organic polymeric compound. According to this proposal, in order to flame-retard the biodegradable organic polymeric compound such as poly lactic acid, 30 parts by mass to 60 parts by mass, based on 140 parts by mass of the organic polymeric compound, of the flame retardant additive containing the phosphorus-containing compound should be added. Since the flame retardant additive containing the phosphorus-containing compound uses a fossil resource as the starting material, the proportion of biomass is disadvantageously lowered.

Regarding a technique for flame-retarding resin materials using biomass as a starting material, in order to overcome a problem of a high environment load involved in conventional flame retardant materials using petroleum materials, JP-A No. 2002-356579 proposes a process for producing an organic-inorganic hybrid flame retardant cellulose material that includes mixing and homogeneously dispersing 0.1 part by mass to 150 parts by mass of an alkoxysilane compound (B) into 100 parts by mass of acetylcellulose (A), then eliminating the acetyl group partially or completely and hydrolyzing and condensing the alkoxysilane compound.

According to the proposed method, the acetylcellulose and the alkoxysilane compound are merely kneaded with each other to obtain the organic-inorganic hybrid flame retardant cellulose material. The results of a test of the organic-inorganic hybrid flame retardant cellulose material by a method according to UL94 combustion test show that the combustion time of specimens is increased, but on the other hand, the specimens are completely burned out, indicating that the flame retardancy is unsatisfactory. This patent document describes that the material is moldable, but there is no concrete working example on the molding.

In order to accomplish a task of a flame retardant material that is free from the generation of toxic gases such as dioxin, develops flame retardancy and utilizes a biomass material, International Publication No. WO2003/082987 proposes a polymeric composition containing a polymeric substance and a flame retardant, the flame retardant containing a polymer having on its side chain a flame retardant compound. Specifically, the flame retardant is a polymer that has on its side chain a heterocyclic compound containing nitrogen as a hetero atom and uses an organism-derived substance such as a nucleic acid base in a part of monomers for the polymer.

The flame retardant material in this proposal contains a polymeric material having on its side chain a flame retardant heterocyclic compound containing a hetero atom, but is disadvantageous in that the polymeric material as a starting material is not a biomass material and cannot provide a low environment load due to the addition of a large amount. In this conventional technique, a thermoplastic resin is kneaded with the flame retardant. According to this method, the flame retardancy is developed. However, when molding of the composition for use as a molded product is taken into consideration, due to a lowering in affinity between the thermoplastic resin and the flame retardant, disadvantageously, the fluidity of the resin is deteriorated, leading to deteriorated moldability and potentially leading to lowered physical properties.

In order to accomplish a task that simultaneous realization of physical properties such as strength and flame retardancy increases the dependency on petroleum products, JP-A No. 2004-256809 proposes a flame retardant polyester resin composition containing 50% by mass to 80% by mass of a naturally occurring biodegradable polyester resin (A) and 50% by mass to 20% by mass of a thermoplastic polyester resin (B) produced by copolymerizing an organophosphorus compound. Specifically, polyethylene terephthalate (PET) or polybutylene succinate (PBS) copolymerized with an organophosphorus compound is blended with poly lactic acid.

According to this proposal, however, polyethylene terephthalate is produced using a petroleum-derived starting material, and, further, at the present time, succinic acid and butanediol as starting materials for polybutylene succinate are also petroleum-derived. Accordingly, disadvantageously, there is only little difference in the degree of biomass between this proposed material and the conventional flame retardant. In this conventional technique, an organophosphorus compound is copolymerized in the structure of the thermoplastic polyester resin. This means that an organophosphorus compound is introduced into a main chain of the thermoplastic polyester resin. Further, due to a feature of the development of flame retardancy by the organophosphorus compound, the flame retardancy is developed by the elimination of phosphorus. Since, however, phosphorus is introduced into the main chain, the elimination is less likely to occur. Even though the elimination successfully occurs, the main chain is cut off, the molecular weight is lowered. Consequently, dripping is likely to occur, and it becomes difficult to ensure flame retardancy. Accordingly, for transfer to lower dependency on petroleum, even when the biomass-derived thermoplastic polyester resin in which the organophosphorus compound is copolymerized is used, the task of simultaneously meeting both the physical properties and the flame retardancy cannot be accomplished.

JP-A No. 2010-31230 proposes a flame retardant resin composition containing at least a thermoplastic resin and a flame retardant, the flame retardant being a phosphorus-containing polysaccharide in which a phosphoric ester is added to a side chain of a naturally occurring polysaccharide. JP-A No. 2010-31229 proposes a flame retardant resin composition containing at least a thermoplastic resin and a flame retardant, the flame retardant being a phosphorus-containing polysaccharide in which a thiophosphoric ester is added to a side chain of a naturally occurring polysaccharide. These proposed compositions have low dispersibility in a resin, so that the task of simultaneously meeting both the physical properties and the flame retardancy cannot be accomplished.

JP-A No. 2012-193337 proposes a flame retardant resin composition containing a thermoplastic resin and a flame retardant, the flame retardant containing a phosphorylated lignin derivative, and the phosphorylated lignin derivative being produced by adding phosphoric acid to a lignin derivative obtained by at least subjecting a naturally occurring lignin to a predetermined treatment. According to the flame retardant resin composition, a low-environment load-type flame retardant resin material can be obtained that has flame retardancy and a high degree of biomass. However, this proposed material needs to contain the flame retardant in an amount of 20% or more. Additionally, the material does not form a foamed carbonized layer. Therefore, the task of simultaneously meeting both the physical properties and the flame retardancy cannot be accomplished.

Accordingly, any flame retardant resin composition having satisfactory properties that has a low petroleum dependency, a high degree of biomass, and a low environment load, as well as physical properties and flame retardancy has not been obtained yet, and, thus, further improvement and development have been demanded in the art.

### SUMMARY OF THE INVENTION

The present invention has been made in view of the foregoing, and aims to solve the above existing problems and achieve the following objects.

An object of the present invention is to provide a flame retardant resin composition that has a low petroleum dependency, a high degree of biomass, a low environment load, and, at the same time, flame retardancy.

Another object of the present invention is to provide a flame retardant resin composition that achieves high flame retardancy even with addition of a small amount of a flame retardant.

A flame retardant resin composition of the present invention which can achieve the above objects is as follows.

A flame retardant resin composition, containing:

a thermoplastic resin; and

a flame retardant,

wherein the flame retardant contains a nitrogen-containing structure-introduced phosphorylated lignin derivative,

wherein the nitrogen-containing structure-introduced phosphorylated lignin derivative is produced by introducing a nitrogen-containing structure into a lignin derivative and adding a phosphoric acid to the lignin derivative, or by adding a phosphoric acid to a lignin derivative and introducing a nitrogen-containing structure into the lignin derivative, or by introducing a nitrogen-containing structure into and adding a phosphoric acid to a lignin derivative simultaneously, and

wherein the lignin derivative is obtained by subjecting a naturally occurring lignin to a treatment for allowing the naturally occurring lignin to be decomposed into small molecules or to be water-soluble.

The present invention can provide a flame retardant resin composition that has a low petroleum dependency, a high degree of biomass, a low environment load, and, at the same time, flame retardancy. The present invention can prevent physical properties of the resin composition from deteriorating, because of addition of only a small amount of a flame retardant.

### DETAILED DESCRIPTION OF THE INVENTION

### Flame Retardant Resin Composition

A flame retardant resin composition of the present invention contains at least a thermoplastic resin and a flame retardant; and, if necessary, further contains other ingredients.

The flame retardant contains a nitrogen-containing structure-introduced phosphorylated lignin derivative.

The nitrogen-containing structure-introduced phosphorylated lignin derivative is produced by introducing a nitrogen-containing structure into a lignin derivative to thereby obtain a nitrogen-containing structure-introduced lignin derivative, and adding a phosphoric acid to the nitrogen-containing structure-introduced lignin derivative.

The lignin derivative is obtained by subjecting a naturally occurring lignin to a treatment for allowing the naturally occurring lignin to be decomposed into small molecules or to be water-soluble.

According to a flame retardant resin composition of the present invention, a flame retardant resin material that has flame retardancy, a high degree of biomass and a low environment load can be obtained. Further, a high level of dispersibility in resin can be obtained through the action of a hydrophilic group possessed by the lignin derivative. Furthermore, the lignin derivative has caking properties due to the nature of a polymeric substance, can realize a stable dispersion state in a resin and, thus, can suppress bleedout in use. In addition, the lignin derivative affects formation of a foaming layer upon combustion, and thus can improve flame retardancy.

In the present invention, a carbonized layer is formed through phosphorylation upon combustion. Additionally, a nitrogen gas is generated as a decomposed gas upon combustion because the flame retardant contains a nitrogen structure and a foamed carbonized layer is formed. These layers are believed to impart flame retardancy to the resin composition.

### <Flame Retardant>

The flame retardant contains a nitrogen-containing structure-introduced phosphorylated lignin derivative produced by introducing a nitrogen-containing structure into a lignin derivative to thereby obtain a nitrogen-containing structure-introduced lignin derivative, and adding a phosphoric acid to the nitrogen-containing structure-introduced lignin derivative. The lignin derivative is obtained by subjecting a naturally occurring lignin to a predetermined treatment.

Examples of the naturally occurring lignin include lignin contained in natural wood, and lignin contained in herbaceous plants such as paddy straw or wheat straw.

The lignin derivative can be obtained by subjecting the naturally occurring lignin to a predetermined treatment.

Representative example of the predetermined treatment includes a treatment in which lignin is removed from natural wood to thereby obtain pulp. One example thereof includes a pulp treatment through a kraft process. The pulp treatment through a kraft process is a method in which an aqueous sodium hydroxide solution and an aqueous sodium sulfide solution are brought into a cooking liquor, and which allows the natural wood to be decomposed into small molecules for isolating lignin therefrom.

Other examples of the predetermined treatment include a water-solubilization treatment in which a residual lignin produced by saccharifying a starting material such as wood with sulfuric acid is hydrothermally treated in an aqueous alkali solution; a water-solubilization treatment in which a herbaceous material such as paddy straw or wheat straw is treated in an aqueous alkali solution: a decomposition treatment in which a starting material such as natural wood and herbaceous plants is saccharified with an enzyme. Examples of the lignin derivative include kraft lignins; hydrothermally treated sulfuric acid lignins (products obtained by hydrothermally treating a residual lignin (a sulfuric acid lignin), produced by saccharifying a starting material such as wood with sulfuric acid, in an aqueous alkali solution for water solubilization); alkali lignins (products obtained by treating a starting material such as paddy straw or wheat straw in an aqueous alkali solution for water solubilization); and enzyme saccharified residual lignins.

The use of a kraft lignin as the lignin derivative can achieve flame retardancy even with inexpensive starting materials. Further, a kraft lignin (a black liquor) used in cascading as a fuel can be used as a highly functional material, contributing to a lowered environment load. The use of an alkali lignin as the lignin derivative allows the alkali lignin (products obtained after separating a pulp material from a starting material such as paddy straw or wheat straw) which has not been utilized as a resource to be used. In addition, a saccharified residual lignin (products obtained by saccharifying a cellulose component from wood) which has also not been utilized as a resource can be used, making it possible to attain flame retardancy using inexpensive starting materials.

For introducing a nitrogen-containing structure into the lignin derivative, the lignin derivative is allowed to react with a nitrogen-containing compound.

The nitrogen-containing structure is preferably an amino group-containing structure. For introducing the amino group-containing structure into the lignin derivative, the lignin derivative is preferably allowed to react with an amine compound.

Preferable examples of the amine compound include dimethylamine, guanidine, and melamine.

The guanidine preferably contains a methyl group.

Examples of other compounds containing a nitrogen-containing structure include: N-butyldimethylamine, N-acetyldimethylamine, N-acetoacetyldimethylamine, 2-(dimethylamino)ethanol, N,N-dimethylbenzylamine, N,N-dimethylcyclohexylamine, N,N-dimethylethylamine, N,N-dimethylformamide; acetylacetone guanidine, nitro guanidine, 1-methyl-3-nitro guanidine, cyano guanidine, 1,3-diphenyl guanidine, 1,3-di-o-tolyl guanidine; trichloro melamine, 2,4,6-tris[bis(methoxymethyl)amino]-1,3,5-triazine, 2,4-diamino-6-(cyclopropylamino)-1,3,5-triazine 2,4-diamino-6-butylamino-1,3,5-triazine, and 2,4-diamino-6-diallylamino-1,3,5-triazine.

The nitrogen-containing structure-introduced phosphorylated lignin derivative can be obtained by further adding phosphoric acid to the nitrogen-containing structure-introduced lignin derivative produced by introducing the nitrogen-containing structure into the lignin derivative.

A method for adding phosphoric acid may be a method in which phosphoryl chloride is added to thereby allow to react in a pyridine solution.

The nitrogen-containing structure is preferable introduced into a hydroxymethylated lignin derivative. A nitrogen-containing structure-introduced hydroxymethylated phosphorylated lignin derivative can be obtained by adding phosphoric acid to a nitrogen-containing structure-introduced hydroxymethylated lignin.

The lignin derivative can be hydroxymethylated by allowing it to react with formamide.

Incorporation of the nitrogen-containing structure-introduced hydroxymethylated phosphorylated lignin derivative into a resin as a flame retardant increases a thermal decomposition temperature of the resin, which can improve heat-resistance of the resin.

A phosphorus content in the flame retardant is preferably 3% by mass to 15% by mass, more preferably 7% by mass to 15% by mass.

A nitrogen content in the flame retardant is preferably 2% by mass to 15% by mass, more preferably 5% by mass to 15% by mass.

The flame retardant resin composition of the present invention preferably contains 5% by mass to 30% by mass, more preferably 10% by mass to 20% by mass of the flame retardant.

### <Thermoplastic Resin>

The thermoplastic resin preferably contains an aromatic polyester, an aliphatic polyester, or both thereof, and more preferably contains an aromatic polyester containing a carbonate bond or an aliphatic polyester containing a carbonate bond. Inclusion of the thermoplastic resin can further improve flame retardancy.

Biomass is preferably used as at least a part of the starting material of the thermoplastic resin. Use of the biomass as at least a part of the starting material can achieve a flame retardant resin material which has a high degree of biomass and a low environment load, as well as flame retardancy.

It is preferable that the thermoplastic resin contained in the flame retardant resin composition contain 50% by mass or more of an aromatic polyester containing a carbonate bond or an aliphatic polyester containing a carbonate bond, from the viewpoint of high flame retardancy. However, for the purpose of contributing to reduction of an amount of petroleum used and an amount of carbon dioxide emissions, a biomass resin is preferably used, and the biomass resin is preferably contained in an amount of 20% by mass or more, more preferably in an amount of 50% by mass or more.

Examples of the aromatic polyester include polyethylene terephthalate (PET), polybutylene succinate (PBS), polytrimethylene terephthalate (PTT), aromatic polycarbonate resins, liquid crystalline polymers (LCP), and non-crystalline polyallylates.

The aromatic polycarbonate resin may be appropriately synthesized products or alternatively may be commercially available products. Examples of such commercially available products include PANLITE (trade name) manufactured by Teijin Chemicals Ltd. and IUPILON (trade name) manufactured by Mitsubishi Engineering-Plastics Corporation.

Examples of the aliphatic polyester include poly lactic acids (PLAs), microorganism-producing polyhydroxy alkanoates (PHAs), polybutylene succinates (PBSs), and aliphatic polycarbonate resins.

Examples of the aliphatic polycarbonate resins include polypropylene carbonates, polyethylene carbonates, and alicyclic polycarbonates having a cyclic structure.

The aliphatic polyester may be appropriately synthesized products or alternatively may be commercially available products.

The above resin materials may be blended with other resins as long as the effects of the present invention are not significantly impaired.

### <Flame Retardant Auxiliary>

The flame retardant resin composition of the present invention may further contain a flame retardant auxiliary, if necessary.

The flame retardant auxiliary is not particularly limited. For example, the flame retardant auxiliary may be at least one or more selected from the group consisting of phosphorus flame retardants, nitrogen compound flame retardants, silicone flame retardants, bromine flame retardants, inorganic flame retardants, and polyfluoroolefins. Inclusion of the flame retardant auxiliary can further improve flame retardancy.

### —Phosphorus Flame Retardant—

The phosphorus flame retardant is not particularly limited. For example, commercially available phosphorus flame retardants may be used. Examples of the phosphorus flame retardants include triphenyl phosphate, cresyl diphenyl phosphate, tricresyl phosphate, trixylenyl phosphate, tris(t-butylated phenyl)phosphate, tris(i-propylated phenyl)phosphate, 2-ethylhexyldiphenyl phosphate, 1,3-phenylenebis(diphenyl phosphate), 1,3-phenylenebis(dixylenyl)phosphate, bisphenol A (diphenyl phosphate), tris(dichloropropyl)phosphate, tris(β-chloropropyl)phosphate, tris(chloroethyl)phosphate, 2,2-bis(chloromethyl)trimethylenebis(bis(2-chloroethyl)phosphate), polyoxyalkylene bisdichloroalkyl phosphate, and red phosphorus.

### —Nitrogen Compound Flame Retardant—

The nitrogen compound flame retardant is not particularly limited. Examples thereof include melamine phosphate, melamine pyrophosphate, melamine polyphosphate, and ammonium polyphosphate.

### —Silicone Flame Retardant—

The silicone flame retardant is not particularly limited. Examples thereof include silicone resins, silicone rubbers, and silicone oils.

Examples of the silicone resins include resins having a three-dimensional network structure containing a combination of structural units of SiO₂, RSiO_{3/2}, R₂SiO, and R₃SiO_{1/2}. In the formulae, R denotes an alkyl group such as a methyl, ethyl or propyl group; an aromatic group such as a phenyl or benzyl group; or a substituent containing a vinyl group incorporated in any of the above substituents.

Examples of silicone oils include polydimethylsiloxanes, modified polysiloxanes in which at least one methyl group at a side chain or a terminal of polydimethylsiloxane is modified with at least one selected from the group consisting of a hydrogen atom, an alkyl group, a cyclohexyl group, a phenyl group, a benzyl group, an amino group, an epoxy group, a polyether group, a carboxyl group, a mercapto group, a chloroalkyl group, an alkyl higher alcohol ester group, an alcohol group, an aralkyl group, a vinyl group, and a trifluoromethyl group.

### —Bromine Flame Retardant—

The bromine flame retardant is not particularly limited, and, for example, commercially available bromine flame retardants can be used. Examples of the bromine flame retardant include decabromodiphenyl ether, tetrabromobisphenol-A, bis(pentabromophenyl)ethane, 1,2-bis(2,4,6-tribromophenoxy)ethane, 2,4,6-tris(2,4,6-tribromophenoxy)-1,3,5-triazine, 2,6- (or 2,4-) dibromophenol, brominated polystyrene, polybrominated styrene, ethylenebistetrabromo phthalimide, hexabromocyclododecane, hexabromobenzene, pentabromobenzyl acrylate, and pentabromobenzyl acrylate.

### —Inorganic Flame Retardant—

The inorganic flame retardant is not particularly limited. Examples thereof include magnesium hydroxide, aluminum hydroxide, antimony trioxide, and antimony pentoxide.

### —Polyfluoroolefin—

The polyfluoroolefin is not particularly limited, and may be commercially available polyfluoroolefins. METABULENE Type A (trade name; manufactured by Mitsubishi Rayon Co., Ltd.), which is polyfluoroolefin covered with a methyl methacrylate resin, can be used.

An optimal content of the flame retardant auxiliary may vary depending upon the type of the flame retardant, but is not particularly limited and may be appropriately selected depending on the intended purpose. The flame retardant auxiliary is preferably contained in an amount of 0.1% by mass to 10% by mass, further preferably 1% by mass to 5% by mass.

### <Other Ingredients>

The other ingredients are not particularly limited and may be appropriately selected from conventionally known additives used in the flame retardant resin composition depending on the intended purpose. Examples thereof include compatibilizers, plasticizer, antioxidants, ultraviolet absorbers, processing aids, antistatic agents, colorants, hydrolysis inhibitors, and crystallization nucleating agents. These other ingredients may be appropriately selected and added in such an amount that does not impair the effects of the present invention. The other ingredients may be used alone or in combination.

Examples of the hydrolysis inhibitors include carbodiimide-modified isocyanates, organic phosphite metal salt compounds, tetraisocyanate silanes, monomethylisocyanate silanes, alkoxysilanes, styrene-2-isopropenyl-2-oxazoline copolymers, and 2,2-m-phenylenebis(2-oxazoline).

Examples of the crystallization nucleating agents include talc nucleating agents, nucleating agents containing phenyl-containing metal salt materials, and benzoyl compound-based nucleating agents. Other conventionally known crystallization nucleating agents such as lactate, benzoate, silica, phosphoric ester salt-based crystallization nucleating agents are usable without any problem.

The flame retardant resin composition of the present invention has excellent moldability and is suitable for use in various fields. The flame retardant resin composition of the present invention can be molded into molded products having various shapes, structures, and sizes, and is particularly suitable for use in the production of a molded product of the present invention which will be described later.

### (Molded Product)

A molded product of the present invention is not particularly limited and the shape, structure, and size thereof may be appropriately selected depending on the intended purpose, as long as it is molded from the flame retardant resin composition according to the present invention.

A method for molding is not particularly limited and may be appropriately selected from conventionally known methods depending on the intended purpose. Examples of the method include film molding, extrusion molding, injection molding, blow molding, compression molding, transfer molding, calender molding, thermoforming, flow molding, and laminate molding. Among them, preferable is any method selected from the group consisting of film molding, extrusion molding, and injection molding, and particularly preferable is injection molding in the case where the molded product is used, for example, as image output equipment such as copying machines and printers and electric/electronic equipment such as home electric appliances.

For example, for molding of casing components such as exterior covers of copying machines, molded products that satisfy appearance and dimension requirements can be obtained by molding by means of a 350-ton electric injection molding machine and a mold, the temperature of which can be regulated with a water temperature regulator, under a molding condition of a mold temperature of 40° C., an injection pressure of 90 MPa, and an injection speed of 10 mm/sec.

The flame retardant resin composition of the present invention described above can appropriately contain various conventionally known additives. For example, various additives can be appropriately selected and incorporated into the flame retardant resin composition such as compatibilizers, plasticizer, antioxidants, ultraviolet absorbers, processing aids, antistatic agents, colorants, and hydrolysis inhibitors.

### —Applications—

The molded product of the present invention has flame retardancy as well and is suitable for use as components usable in image output equipment utilizing electrophotographic techniques, printing techniques, or inkjet techniques such as copying machines and laser printers; and interior components in electric/electronic equipment such as home electric appliances and automobiles.

### EXAMPLES

The present invention will be described with reference to the following Examples. However, it should be noted that the present invention is not limited to these Examples.

Examples and Comparative Examples of the flame retardant resin composition of the present invention were produced and subjected to a combustion test and thermogravimetry.

### Example 1

### Preparation of Lignin Derivative

A kraft lignin was used as a lignin derivative.

The kraft lignin in Example 1 is contained in a cooking liquor (a black liquor) discharged in the production of pulp by a kraft process in which an aqueous sodium hydroxide solution and an aqueous sodium sulfide solution are brought into a cooking liquor. In Example 1, LIGNIN, ALKALI (370959), a reagent manufactured by Sigma-Aldrich Co. LLC., was used as the kraft lignin.

### <Introduction of Dimethylamine by Mannich Reaction>

A kraft lignin (10 g, LIGNIN, ALKALI, manufactured by Sigma-Aldrich Co. LLC.) was dissolved into a mixed solution of 80% by mass dioxane (300 mL) and acetic acid (30 mL). With stirring, a 50% by mass dimethylamine solution (22.5 mL, 0.25 mol) and a 37% by mass formamide solution (18.7 mL, 0.25 mol) were added thereto, followed by allowing to react for 4 hours in a 60° C. water bath. Thereafter, the resultant reaction solution was added dropwise to acetone to form a precipitate. The precipitate was suction-filtered and residues were washed with water, followed by drying in a desiccator to thereby obtain a reaction product.

<Phosphorylation with Phosphoryl Chloride>

The resultant reaction product was dissolved into pyridine (250 mL). With stirring, phosphoryl chloride (20 mL, 0.21 mol) was added thereto, followed by allowing to react for 1 hour. Thereafter, the resultant reaction solution was added dropwise to water to thereby terminate the reaction, followed by centrifugation (11,000 rpm, 10 min). The resultant precipitate was repeatedly washed with acetone and air-dried in a fume hood to thereby obtain a reaction product. The phosphorus content in the resultant reaction product was measured by a flask combustion method (a titration method). The nitrogen content in the reaction product was measured by an elemental analysis using “2400II” (manufactured by PerkinElmer Inc.). Results are shown in Tables 1-1 and 1-2. It was confirmed that a nitrogen-containing phosphorylated lignin derivative having the phosphorus content of 6% by mass or more but less than 8% by mass and the nitrogen content of 3% by mass to 4% by mass was obtained.

### <Preparation of Flame Retardant Resin Composition>

To 85 parts by mass of poly lactic acid, were added 15 parts by mass of the above-prepared amino group structure-introduced phosphorylated lignin derivative produced through Mannich reaction and 0.5 parts by mass of polyfluoroolefin, followed by dry-blended together. The resultant blend was melt-kneaded with a twin-screw kneader/extruder at a temperature of 170° C. to prepare molding pellets of about 3 mm square.

LACEA H100-J manufactured by Mitsui Chemicals Inc. was used as the poly lactic acid. METABLEN A-3800 manufactured by Mitsubishi Rayon Co., Ltd. was used as the polyfluoroolefin.

### <Preparation of Specimen for UL94 Vertical Combustion Test>

The above-prepared molding pellets were dried with a shelf-type hot-air drier at 60° C. for 5 hr. Thereafter, a strip specimen for a UL94 vertical combustion test was prepared with an electric injection molding machine (clamping force: 100 tons) under a condition of a mold temperature of 40° C., a cylinder temperature of 190° C., an injection speed of 20 mm/sec, an injection pressure of 100 MPa, and a cooling time of 30 sec. The above-prepared strip specimen was found to have a size of 13 mm in width, 125 mm in length, and 1.6 mm in thickness.

### <UL94 Vertical Combustion Test>

The above-prepared specimens were aged at 50° C. for 72 hour and were then cooled in a desiccator at a humidity of 20% for 3 hour. Subsequently, specimens (one set consisting of five specimens) were subjected to a vertical combustion test according to UL94 standards. A testing method will be described below.

An upper end of each specimen is clamped and is kept in a vertical state. An absorbent cotton (0.8 g or less, 50 mm square) is placed 300 mm±10 mm below a lower end of each specimen, followed by subjecting to the below-described combustion test to examine whether or not a molten specimen drops on the absorbent cotton. A flame from a burner was brought into contact with each specimen from its lower end for 10 sec±1 sec (first time). Thereafter, the burner was separated away from the specimen at a speed of about 300 mm/sec. Immediately after terminating combustion, the burner is returned to the lower end of the specimen and the flame was again brought into contact with the lower end of the specimen for 10 sec±1 sec (second time). For specimens (one set consisting of five specimens), the flame was brought into contact with the specimen for 10 times in total, and a combustion time was recorded for each specimen. As used herein, the term “combustion time” means a combustion duration time after the flame was separated away from the specimen. The combustion time for the first time, the combustion time for the second time, and a fire source duration time after the second combustion were designated as t1, t2, and t3, respectively. As used herein, the phrase “fire source duration time after the second combustion” means a time for which a red fire source remains on the specimen although the flame has extinguished.

### <Method for Determination of Results of UL94 Vertical Combustion Test>

The results of the UL94 vertical combustion test were determined according to the following methods (1) to (5).

(1) For each specimen, the results were evaluated as V-0 when the measured combustion times t1, t2 were 10 sec or less; and the results were evaluated as V-1 or V-2 when the measured combustion times t1, t2 were 30 sec or less. Here, V-1 was distinguished from V-2 based on whether the cotton was ignited at a time when a molten specimen was dropped thereon during the combustion, according to the following (5).
Specifically, the results were evaluated as V-2 when the cotton was ignited; and the results were evaluated as V-1 when the cotton was not ignited.
(2) The results were evaluated as V-0 when the combustion times (t1+t2) for all the five specimens were 50 sec or less; and the results were evaluated as V-1 or V-2 when the combustion times (t1+t2) for all the five specimens were 250 sec or less.
(3) The results were evaluated as V-0 when the total of the combustion time for the second time and fire source duration time after the second combustion, i.e., t2+t3, was 30 sec or less; and the results were evaluated as V-1 or V-2 when t2+t3 was 60 sec or less.
(4) The results were evaluated as acceptable when the combustion did not reach the clamp.
(5) Ignition of the adsorbent cotton with a combustion product of the specimen or a dropped specimen was evaluated. The results were evaluated as V-0 or V-1 when the cotton was not ignited; and the results were evaluated as V-2 when the cotton was ignited.

Here, when the cotton was not ignited, V-0 was distinguished from V-1 based on the results of measurement of combustion times (t1+t2) and (t2+t3) in the above (2) and (3). The results were evaluated as V-0 when t1+t2 was 50 sec or less; and the results were evaluated as V-1 when t1+t2 was more than 50 sec and 250 sec or less. The results were evaluated as V-0 when t2+t3 was 30 sec or less; and the results were evaluated as V-1 when t2+t3 was more than 30 sec and 60 sec or less.

For each of the above (1) to (5), the results were evaluated as an acceptable level from a practical viewpoint when all the V-0, V-1, and V-2 requirements were simultaneously satisfied.

### <Thermogravimetric Measurement>

In a thermogravimetric analysis, a residual mass was measured with TG-DTA2000A manufactured by Mac Science when a sample was heated from room temperature to 500° C. at a temperature rise rate of 5° C./min under an air atmosphere. The mass at a temperature of 100° C. was used as a reference, and the sample was evaluated based on the proportion (%) of the residual mass relative to the reference.

### Examples 2

The following reaction product was obtained using the kraft lignin described in Example 1 as a starting material.

<Introduction of Dimethylamine and Phosphorylation with Phosphoryl Chloride>

The kraft lignin (10 g) was dissolved into pyridine (250 mL). With stirring, phosphoryl chloride (10 mL, 0.11 mol) was added thereto. After 1 hour, a mixed solution of a 50% by mass dimethylamine solution (60 mL, 0.67 mol) and pyridine (60 mL) was additionally added. After 1 hour, the resultant reaction solution was added dropwise to water to thereby terminate the reaction, followed by centrifugation (11,000 rpm, 15 min). The resultant precipitate was repeatedly washed with acetone and air-dried in a fume hood to thereby obtain a reaction product. The phosphorus content in the resultant reaction product was measured by the flask combustion method (the titration method). The nitrogen content in the reaction product was measured by the elemental analysis. Results are shown in Tables 1-1 and 1-2. It was confirmed that a nitrogen-containing phosphorylated lignin derivative having the phosphorus content of 10% by mass or more but less than 12% by mass and the nitrogen content of 3% by mass to 4% by mass was obtained.

A flame retardant resin composition was produced, and subjected to the combustion test and thermogravimetry in the same manner as in Example 1. Results are Table 2.

### Example 3

The following reaction product was obtained using the kraft lignin described in Example 1 as a starting material.

### <Hydroxymethylation of Kraft Lignin>

The kraft lignin (10 g) was dissolved into a 1 N aqueous sodium hydroxide solution (500 mL). With stirring in a 60° C. water bath, a 37% by mass formaldehyde solution (100 mL, 1.3 mol) was added thereto. After 2 hours, a 37% by mass formaldehyde solution (100 mL, 1.3 mol) was additionally added thereto. Six hours after initiating the reaction, the resultant reaction solution was acidified with 1 N hydrochloric acid, followed by centrifugation (11,000 rpm, 30 min). The resultant precipitate was subjected to vacuum drying to thereby obtain hydroxymethylated kraft lignin (HKL).

<Introduction of Melamine into Hydroxymethylated Lignin>

The hydroxymethylated lignin was dissolved into a 0.1 N aqueous sodium hydroxide solution (300 mL). With stirring in a 60° C. water bath, melamine (6.4 g, 0.05 mol) was added thereto. Four hours after initiating the reaction, the resultant reaction solution was acidified with 0.1 N hydrochloric acid, followed by centrifugation (11,000 rpm, 10 min) to collect a supernatant. To the supernatant, an amphoteric ion exchange resin (AMBERLITE EG-4) was added, followed by leaving to stand with stirring for 30 min. A supernatant was collected, and freezed at −30° C. to thereby obtain a freezed sample. The freezed sample was subjected to freeze-drying to thereby obtain a reaction product.

<Phosphorylation with Phosphoryl Chloride>

The resultant reaction product was dissolved into pyridine (250 mL). With stirring, phosphoryl chloride (20 mL, 0.21 mol) was added thereto, followed by allowing to react for 1 hour. Thereafter, the resultant reaction solution was added dropwise to water to thereby terminate the reaction, followed by centrifugation (11,000 rpm, 10 min). The resultant precipitate was repeatedly washed with acetone and air-dried in a fume hood to thereby obtain a reaction product. The phosphorus content in the resultant reaction product was measured by the flask combustion method (the titration method). The nitrogen content in the reaction product was measured by N-NMR analysis. Results are shown in Tables 1-1 and 1-2. It was confirmed that a nitrogen-containing phosphorylated lignin derivative having the phosphorus content of 6% by mass or more but less than 8% by mass and the nitrogen content of 5% by mass to 6% by mass was obtained.

A flame retardant resin composition was produced, and subjected to the combustion test and thermogravimetry in the same manner as in Example 1. Results are Table 2.

### Example 4

The following reaction product was obtained using the kraft lignin described in Example 1 as a starting material.

<Introduction of 1,1,3,3-Tetramethyl Guanidine and Phosphorylation with Phosphoryl Chloride>

The kraft lignin (10 g) was dissolved into pyridine (250 mL). With stirring, phosphoryl chloride (10 mL, 0.11 mol) was added thereto. After 1 hour, a mixed solution of 1,1,3,3-tetramethyl guanidine solution (80 mL, 0.64 mol) and pyridine (80 mL) was additionally added thereto. After 1 hour, the resultant reaction solution was added dropwise to water to thereby terminate the reaction, followed by centrifugation (11,000 rpm, 15 min). The resultant precipitate was repeatedly washed with acetone and air-dried in a fume hood to thereby obtain a reaction product. The phosphorus content in the resultant reaction product was measured by the flask combustion method (the titration method). The nitrogen content in the reaction product was measured by the elemental analysis. Results are shown in Table 1. It was confirmed that a nitrogen-containing phosphorylated lignin derivative having the phosphorus content of 6% by mass or more but less than 8% by mass and the nitrogen content of 12% by mass to 13% by mass was obtained.

A flame retardant resin composition was produced, and subjected to the combustion test and thermogravimetry in the same manner as in Example 1. Results are Table 2.

### Example 5

The following reaction product was obtained using the kraft lignin described in Example 1 as a starting material.

### <Introduction of Guanidine by Mannich Reaction>

The kraft lignin (10 g, LIGNIN, ALKALI, manufactured by Sigma-Aldrich Co. LLC.) was dissolved into a mixed solution of 80% by mass dioxane (300 mL) and acetic acid (30 mL). With stirring, a 1,1,3,3-tetramethyl guanidine solution (93.8 mL, 0.75 mol) and a 37% by mass formamide solution (56.3 mL, 0.75 mol) were added thereto, followed by allowing to react for 4 hours in a 60° C. water bath. Thereafter, the resultant reaction solution was acidified with hydrochloric acid. To the resultant acidified solution, was added water in an amount of three times of that of the resultant acidified solution, followed by centrifugation (11,000 rpm. 10 min). The resultant precipitate was dried in a desiccator to thereby obtain a reaction product.

<Phosphorylation with Phosphoryl Chloride>

The reaction product was dissolved into pyridine (250 mL). With stirring, phosphoryl chloride (20 mL, 0.21 mol) was added thereto, followed by allowing to react for 1 hour. Thereafter, the resultant reaction solution was added dropwise to water to thereby terminate the reaction, followed by centrifugation (11,000 rpm, 10 min). The resultant precipitate was repeatedly washed with water and dried in a desiccator to thereby obtain a reaction product. The phosphorus content in the resultant reaction product was measured by the flask combustion method (the titration method). The nitrogen content in the reaction product was measured by the elemental analysis. Results are shown in Tables 1-1 and 1-2. It was confirmed that a nitrogen-containing phosphorylated lignin derivative having the phosphorus content of 3% by mass or more but less than 5% by mass and the nitrogen content of 2% by mass to 3% by mass was obtained.

A flame retardant resin composition was produced, and subjected to the combustion test and thermogravimetry in the same manner as in Example 1. Results are Table 2.

### Example 6

### Preparation of Flame Retardant Resin Composition

To 80 parts by mass of a PC/ABS resin obtained by polymer-alloying a polycarbonate resin with an acrylonitrile-butadiene-styrene copolymer resin, were added 15 parts by mass of the amino group-introduced phosphorylated lignin produced through Mannich reaction prepared in Example 1 and 0.5 parts by mass of polyfluoroolefin, followed by dry-blended together. The resultant blend was melt-kneaded with a twin-screw kneader/extruder at a temperature of 170° C. to prepare molding pellets of about 3 mm square.

MULTILON T-3714 manufactured by Teijin Ltd. was used as the PC/ABS resin. METABLEN A-3800 (acryl-modified polytetrafluoroethylene, manufactured by Mitsubishi Rayon Co., Ltd.) was used as the polyfluoroolefin.

### <Preparation of Specimen for UL94 Vertical Combustion Test>

The above-prepared molding pellets were dried with a shelf-type hot-air drier at 80° C. for 5 hour. Thereafter, a strip specimen for the UL94 vertical combustion test was prepared with an electric injection molding machine (clamping force: 100 tons) under a condition of a mold temperature of 60° C., a cylinder temperature of 240° C., an injection speed of 20 mm/sec, an injection pressure of 100 MPa, and a cooling time of 30 sec. The above-prepared strip specimen was found to have a size of 13 mm in width, 125 mm in length, and 1.6 mm in thickness.

A specimen for the UL94 vertical combustion test prepared as described above was subjected to the combustion test under the same conditions as in Example 1. Thermogravimetry was performed under the same conditions as in Example 1.

### Example 7

### Preparation of Flame Retardant Resin Composition

To 80 parts by mass of a PC/ABS resin obtained by polymer-alloying a polycarbonate resin with an acrylonitrile-butadiene-styrene copolymer resin, 10 parts by mass of the amino group-introduced phosphorylated lignin prepared in Example 2, 5 parts by mass of a flame retardant auxiliary, and 0.5 parts by mass of polyfluoroolefin, followed by dry-blended together. The resultant blend was melt-kneaded with a twin-screw kneader/extruder at a temperature of 170° C. to prepare molding pellets of about 3 mm square.

MULTILON T-3714 manufactured by Teijin Ltd. was used as the PC/ABS resin. METABLEN A-3800 (acryl-modified polytetrafluoroethylene, manufactured by Mitsubishi Rayon Co., Ltd.) was used as the polyfluoroolefin. ADEKA STAB FP-800 manufactured by ADEKA corporation was used as the flame retardant auxiliary.

### <Preparation of Specimen for UL94 Vertical Combustion Test>

The above-prepared molding pellets were dried with a shelf-type hot-air drier at 80° C. for 5 hour. Thereafter, a strip specimen for the UL94 vertical combustion test was prepared with an electric injection molding machine (clamping force: 100 tons) under a condition of a mold temperature of 60° C., a cylinder temperature of 240° C., an injection speed of 20 mm/sec, an injection pressure of 100 MPa, and a cooling time of 30 sec. The above-prepared strip specimen was found to have a size of 13 mm in width, 125 mm in length, and 1.6 mm in thickness.

A specimen for the UL94 vertical combustion test prepared as described above was subjected to the combustion test under the same conditions as in Example 1. Thermogravimetry was performed under the same conditions as in Example 1.

### Comparative Examples 1 and 2

### Production of Flame Retardant Resin Composition

To 80 parts by mass of poly lactic acid, were added 20 parts by mass of each of the kraft lignin and the alkali lignin used as a starting material in Example 1 and 0.5 parts by mass of polyfluoroolefin, followed by dry-blended together. The resultant blend was melt-kneaded with a twin-screw kneader/extruder at a temperature of 170° C. with a twin-screw kneader/extruder to prepare molding pellets of about 3 mm square.

LACEA H100J manufactured by Mitsui Chemicals Inc. was used as the poly lactic acid. Herbaceous lignin manufactured by Harima Chemicals Group, Inc. was used as the alkali lignin. METABLEN A-3800 manufactured by Mitsubishi Rayon Co., Ltd. was used as the polyfluoroolefin.

A specimen for the UL94 vertical combustion test was prepared using the molding pellet and was subjected to the combustion test under the same conditions as in Example 1. Thermogravimetry was performed under the same conditions as in Example 1.

### Comparative Example 3

A specimen for the UL94 vertical combustion test was prepared and was subjected to the combustion test under the same conditions as in Example 1, except that the PC/ABS resin (MULTILON T-3714 manufactured by Teijin Ltd.) used in Example 4 was used. Thermogravimetry was performed under the same conditions as in Example 1.

### (Results)

For the resin compositions used in Examples 1 to 7 and Comparative Examples 1 to 3, the blending ratio and the results of the UL94 vertical combustion test and the thermogravimetry are shown in Tables 2. The results of the combustion test were indicated by NG when the sample did not satisfy the V-2 requirement.

For Examples 1 to 4, the 500° C. residual mass in the thermogravimetry was 9% or more, and the results of the combustion test satisfied the V-2 requirement.

For Example 5, the 500° C. residual mass in the thermogravimetry was 4.1% or more, and the results of the combustion test satisfied the V-2 requirement. For Example 6, the 500° C. residual mass in the thermogravimetry was 21.3% or more, and the results of the combustion test satisfied the V-1 requirement.

For Example 7, the 500° C. residual mass in the thermogravimetry was 22.8% or more, and the results of the combustion test satisfied the V-1 requirement.

On the other hand, in the case where the lignin material was added to the thermoplastic resin as in Comparative Examples 1 and 2, there was no 500° C. residue in the thermogravimetry, and, in the combustion test, the sample was completely burned out, indicating that the combustion was NG.

For Comparative Example 3, the amount of the 500° C. residue in the thermogravimetry in the thermoplastic resin per se was slight, and the result of the combustion test was NG.

TABLE 1-1

| | Amino group- | | |
|---|---|---|---|
| | introduced | Amino group- | Melamine- |
| | phosphorylated | introduced | introduced |
| Synthesized | lignin by Mannich | phosphorylated | phosphorylated |
| product | reaction | lignin | lignin |
| Lignin material | Kraft | Kraft | Hydroxy- |
| | lignin | lignin | methylated |
| | | | kraft lignin |
| Weight of | 10 | 10.0 | 10.0 |
| lignin (g) | | | |
| Dimethylamine | 22.5 (0.25 mol) | 60 0 (0.67 mol) | — |
| (mL) | | | |
| Melamine (mL) | — | — | 6.4 (0.05 mol) |
| Tetramethyl | — | — | — |
| guanidine (mL) | | | |
| Phosphoryl | 20.0 (0.21 mol) | 10.0 (0.11 mol) | 20.0 (0.21 mol) |
| chloride (mL) | | | |
| Yield (g) | 8.07 | 11.3 | 13.7 |
| Phosphorus | 6.6 | 10.3 | 6.1 |
| content (%) | | | |
| Nitrogen | 3.4 | 3.8 | 5.6 |
| content (%) | | | |

TABLE 1-2

| | | Guanidine- |
|---|---|---|
| | Guanidine- | introduced |
| | introduced | phosphorylated |
| | phosphorylated | lignin by Mannich |
| Synthesized product | lignin | reaction |
| Lignin material | Kraft lignin | Kraft lignin |
| Weight of lignin (g) | 10.0 | 10.0 |
| Dimethylamine (mL) | — | — |
| Melamine (mL) | — | — |
| Tetramethyl guanidine (mL) | 80.0 (0.64 mol) | 93.8 (0.75 mol) |
| Phosphoryl chloride (mL) | 10.0 (0.11 mol) | 20.0 (0.21 mol) |
| Yield (g) | 9.6 | 6.3 |
| Phosphorus content (%) | 6.0 | 3.5 |
| Nitrogen content (%) | 12.3 | 2.8 |

TABLE 2

| | | Ex. 1 | Ex. 2 | Ex. 3 | Ex. 4 | Ex. 5 | Ex. 6 | Ex. 7 |
|---|---|---|---|---|---|---|---|---|
| Blending | A-1 | 85 | 85 | 85 | 85 | 85 | | |
| ratio | A-2 | | | | | | 85 | 85 |
| | B-1 | 15 | | | | | 15 | |
| | B-2 | | 15 | | | | | 10 |
| | B-3 | | | 15 | | | | |
| | B-4 | | | | 15 | | | |
| | B-5 | | | | | 15 | | |
| | C-1 | | | | | | | 5 |
| | D-1 | 0.5 | 0.5 | 0.5 | 0.5 | 0.5 | 0.5 | 0.5 |
| Test | Flame | V-2 | V-2 | V-2 | V-2 | V-2 | V-1 | V-1 |
| results | retardancy | | | | | | | |
| | Residue | 9.4 | 5.7 | 5.2 | 4.4 | 4.1 | 21.3 | 22.8 |
| | (%) | | | | | | | |

TABLE 3

| | | Comp. | Comp. | Comp. |
|---|---|---|---|---|
| | | Ex. 1 | Ex. 2 | Ex. 3 |
| Blending | A-1 | 80 | 80 | |
| ratio | A-2 | | | 100 |
| | B-6 | 20 | | |
| | B-7 | | 20 | |
| | C-1 | | | |
| | D-1 | 0.5 | 0.5 | |
| Test | Flame | NG | NG | NG |
| results | retardancy | | | |
| | Residue (%) | 0 | 0 | 0.2 |

A-1: Poly lactic acid; LACEA H-100J manufactured by Mitsui Chemicals Inc.
A-2: PC/ABS resin; MULTILON T-3714 manufactured by Teijin Ltd.
B-1: Amino group-introduced phosphorylated lignin by Mannich reaction
B-2: Amino group-introduced phosphorylated lignin
B-3: Melamine-introduced phosphorylated lignin
B-4: Guanidine-introduced phosphorylated lignin
B-5: Guanidine-introduced phosphorylated lignin by Mannich reaction
B-6: Kraft lignin; LIGNIN, ALKALI (370959) manufactured by Sigma-Aldrich Co. LLC.
B-7: Alkali lignin; HERBACEOUS LIGNIN manufactured by Harima Chemicals Group, Inc.
C-1: Phosphorus flame retardant; ADEKA STAB FP-800 manufactured by ADEKA
D-1: Polyfluoroolefin; METABLEN A-3800 manufactured by Mitsubishi Rayon Co., Ltd.

Embodiments of the present invention are as follows.

<1> A flame retardant resin composition, containing:

a thermoplastic resin; and

a flame retardant,

wherein the flame retardant contains a nitrogen-containing structure-introduced phosphorylated lignin derivative,

wherein the nitrogen-containing structure-introduced phosphorylated lignin derivative is produced by introducing a nitrogen-containing structure into a lignin derivative and adding a phosphoric acid to the lignin derivative, or by adding a phosphoric acid to a lignin derivative and introducing a nitrogen-containing structure into the lignin derivative, or by introducing a nitrogen-containing structure into and adding a phosphoric acid to a lignin derivative simultaneously, and

wherein the lignin derivative is obtained by subjecting a naturally occurring lignin to a treatment for allowing the naturally occurring lignin to be decomposed into small molecules or to be water-soluble.

<2> The flame retardant resin composition according to <1>, wherein the nitrogen-containing structure contains an amino group.
<3> The flame retardant resin composition according to <1>, wherein the nitrogen-containing structure is introduced from dimethylamine.
<4> The flame retardant resin composition according to <1>, wherein the nitrogen-containing structure is introduced from guanidine.
<5> The flame retardant resin composition according to <1>, wherein the nitrogen-containing structure is introduced from melamine.
<6> The flame retardant resin composition according to any one of <1> to <5>, wherein the lignin derivative is a hydroxymethylated lignin.
<7> The flame retardant resin composition according to any one of <1> to <6>, wherein the lignin derivative is a kraft lignin.
<8> The flame retardant resin composition according to any one of <1> to <6>, wherein the lignin derivative is an alkali lignin.
<9> The flame retardant resin composition according to any one of <1> to <8>, wherein the thermoplastic resin includes at least one or more selected from the group consisting of an aromatic polyester, an aliphatic polyester, and a carbonate bond-containing polymer.
<10> The flame retardant resin composition according to any one of <1> to <9>, wherein the thermoplastic resin is a thermoplastic resin produced using a biomass as at least a part of a starting material.
<11> The flame retardant resin composition according to any one of <1> to <10>, further containing a flame retardant auxiliary, and

wherein the flame retardant auxiliary includes at least one or more selected from the group consisting of a phosphorus flame retardant, a nitrogen compound flame retardant, a silicone flame retardant, a bromine flame retardant, an inorganic flame retardant, and a polyfluoroolefin.

<12> A molded product produced by molding the flame retardant resin composition according to any one of <1> to <11>.

This application claims priority to Japanese application No. 2013-0421566, filed on Mar. 4, 2013 and incorporated herein by reference.

What is claimed is:

1. A flame retardant resin composition, comprising:
a thermoplastic resin; and
a flame retardant,
wherein the flame retardant comprises a nitrogen-containing structure-introduced phosphorylated lignin derivative,
wherein the nitrogen-containing structure-introduced phosphorylated lignin derivative is produced by introducing a nitrogen-containing structure into a lignin derivative and adding a phosphoric acid to the lignin derivative, or by adding a phosphoric acid to a lignin derivative and introducing a nitrogen-containing structure into the lignin derivative, or by introducing a nitrogen-containing structure into and adding a phosphoric acid to a lignin derivative simultaneously, and
wherein the lignin derivative is obtained by subjecting a naturally occurring lignin to a treatment for allowing the naturally occurring lignin to be decomposed into small molecules or to be water-soluble.

2. The flame retardant resin composition according to claim 1, wherein the nitrogen-containing structure comprises an amino group.

3. The flame retardant resin composition according to claim 1, wherein the nitrogen-containing structure is introduced from dimethylamine.

4. The flame retardant resin composition according to claim 1, wherein the nitrogen-containing structure is introduced from guanidine.

5. The flame retardant resin composition according to claim 1, wherein the nitrogen-containing structure is introduced from melamine.

6. The flame retardant resin composition according to claim 1, wherein the lignin derivative is a hydroxymethylated lignin.

7. The flame retardant resin composition according to claim 1, wherein the lignin derivative is a kraft lignin.

8. The flame retardant resin composition according to claim 1, wherein the lignin derivative is an alkali lignin.

9. The flame retardant resin composition according to claim 1, wherein the thermoplastic resin comprises at least one or more selected from the group consisting of an aromatic polyester, an aliphatic polyester, and a carbonate bond-containing polymer.

10. The flame retardant resin composition according to claim 1, wherein the thermoplastic resin is a thermoplastic resin produced using a biomass as at least a part of a starting material.

11. The flame retardant resin composition according to claim 1, further comprising a flame retardant auxiliary, and
wherein the flame retardant auxiliary comprises at least one or more selected from the group consisting of a phosphorus flame retardant, a nitrogen compound flame retardant, a silicone flame retardant, a bromine flame retardant, an inorganic flame retardant, and a polyfluoroolefin.

12. A molded product produced by molding a flame retardant resin composition,
wherein the flame retardant resin composition comprises a thermoplastic resin and a flame retardant,
wherein the flame retardant comprises a nitrogen-containing structure-introduced phosphorylated lignin derivative,
wherein the nitrogen-containing structure-introduced phosphorylated lignin derivative is produced by introducing a nitrogen-containing structure into a lignin derivative and adding a phosphoric acid to the lignin derivative, or by adding a phosphoric acid to a lignin derivative and introducing a nitrogen-containing structure into the lignin derivative, or by introducing a nitrogen-containing structure into and adding a phosphoric acid to a lignin derivative simultaneously, and
wherein the lignin derivative is obtained by subjecting a naturally occurring lignin to a treatment for allowing the naturally occurring lignin to be decomposed into small molecules or to be water-soluble.

13. The molded product according to claim 12, wherein the nitrogen-containing structure comprises an amino group.

14. The molded product according to claim 12, wherein the nitrogen-containing structure is introduced from dimethylamine.

15. The molded product according to claim 12, wherein the nitrogen-containing structure is introduced from guanidine.

16. The molded product according to claim 12, wherein the nitrogen-containing structure is introduced from melamine.

17. The molded product according to claim 12, wherein the lignin derivative is a hydroxymethylated lignin.

18. The molded product according to claim 12, wherein the lignin derivative is a kraft lignin.

19. The molded product according to claim 12, wherein the lignin derivative is an alkali lignin.

20. The molded product according to claim 12, wherein the thermoplastic resin is a thermoplastic resin produced using a biomass as at least a part of a starting material.
